(19) United States
(12) Patent Application Publication
(10) Pub. No.: US 2025/0117886 A1
(43) Pub. Date: Apr. 10, 2025

(54) IMAGE PROCESSING DEVICE, IMAGE PROCESSING SYSTEM AND METHOD OF OPERATING THE SAME

(71) Applicant: SAMSUNG ELECTRONICS CO., LTD., Suwon-si (KR)

(72) Inventors: Hyuncheol Kim, Suwon-si (KR); Juntaek Kong, Suwon-si (KR); Seungwon Choi, Suwon-si (KR); Jongseong Choi, Suwon-si (KR)

(21) Appl. No.: 18/882,218

(22) Filed: Sep. 11, 2024

(30) Foreign Application Priority Data
Oct. 10, 2023 (KR) 10-2023-0134358

(51) Int. Cl. G06T 5/40; G06T 5/94

(52) U.S. Cl. CPC G06T 5/40; G06T 5/94; G06T 2207/10016; G06T 2207/20021

(57) ABSTRACT

The present disclosure relates to an image processing device to which contrast improvement effect may be applied, an image processing system, and a method of operating the same. An example method of operating an image processing device includes receiving an image including a plurality of pixels, splitting the image into a plurality of first regions, calculating a histogram for a second region that is greater than a first region of the plurality of first regions, generating a contrast conversion function based on the histogram for each of the plurality of first regions, and converting contrast of a current pixel among the plurality of pixels based on M×M first regions among the plurality of first regions adjacent to the current pixel. M is a natural number greater than or equal to 2.

### CROSS-REFERENCE TO RELATED APPLICATION

This application claims priority under 35 U.S.C. §119 to Korean Patent Application No. 10-2023-0134358, filed on Oct. 10, 2023, in the Korean Intellectual Property Office, the disclosure of which is incorporated by reference herein in its entirety.

### BACKGROUND

Image processing systems, such as cameras, may include an image sensor that converts optical signals of an incident object through an optical lens into electrical signals, and a processor that performs image processing on generated images.

When images are captured at a backlight or low light place where a lighting environment is poor, an object cannot be identified because of low brightness of important objects such as a person's face and poor contrast. In order to solve this problem, when brightness of images is entirely increased by using global functions such as gamma, contrast may be lowered, and when a local histogram equalization method is used, flickering problems may occur, where brightness suddenly becomes bright or dark for images where the histogram of each region significantly changes for each frame. Thus, a method of effectively improving contrast of images is required.

### SUMMARY

The present disclosure relates to an image processing device for effectively improving contrast of images, an image processing system, and a method of operating the same.

In general, according to some aspects, a method of operating an image processing device includes receiving an image including a plurality of pixels, splitting the image into a plurality of first regions, calculating a histogram including the first region for each of the plurality of first regions and for a second region that is greater than the first region, generating contrast conversion functions based on the histogram for each of the plurality of first regions, and converting contrast of a current pixel based on M×M (where M is a natural number greater than or equal to 2) first regions among the plurality of first regions adjacent to the current pixel among the plurality of pixels.

In general, according to some aspects, an image processing device includes a histogram calculator configured to receive an image including a plurality of pixels, split the image into N×N (where N is a natural number that is greater than or equal to 2) first regions, including the first regions for each of the N×N first regions, and configured to calculate histograms for a second region that is greater than the first regions, a contrast conversion function generator configured to receive the histograms and to generate contrast conversion functions for each of the N×N first regions based on the histograms, and a result value calculator configured to perform contrast conversion of the current pixel by calculating result values based on the contrast conversion functions and weights of each of H×H (where H is natural number that is greater than or equal to 2 and less than or equal to N) among the first regions adjacent to the current pixel of the plurality of pixels, wherein the result value calculator calculates the weights by taking distances between centers of each of the H×H first regions and the current pixel by reverse numbers based on an order in which the distances taken by reverse numbers are aligned in a descending order.

In general, according to some aspects, an image processing system includes an image sensor configured to output image data including a plurality of pixels, a histogram configured to split the image data into N×N (where N is natural number) first regions, including the first region and configured to calculate histograms for a second region that is greater than the first region, a contrast conversion function generation circuit configured to receive the histograms and to generate contrast conversion functions for each of the N×N first regions based on the histograms, and a result value calculation circuit configured to perform contrast conversion of the current pixel by calculating result values based on the contrast conversion functions and weights of each of H×H (where H is natural number that is greater than or equal to 2 and less than or equal to N) among the N×N first regions adjacent to the current pixel of the plurality of pixels.

### BRIEF DESCRIPTION OF THE DRAWINGS

Implementations will be more clearly understood from the following detailed description taken in conjunction with the accompanying drawings.

FIG. 1 is a block diagram illustrating an example of an image processing system.

FIG. 2 is an example diagram for describing images including a plurality of frames.

FIG. 3 is a flowchart illustrating an example of a method of operating an image processing device.

FIG. 4 is a flowchart illustrating an example of a method of converting contrast of a current pixel in the method of operating an image processing device.

FIG. 5 is a diagram for describing an example of a method of splitting an image into a plurality of regions in the method of operating an image processing device.

FIGS. 6A through 6C are diagrams for describing an example of a method of calculating a histogram and a method of generating contrast conversion functions in the method of operating an image processing device.

FIGS. 7A and 7B are diagrams for describing an example of a method of determining M×M first regions adjacent to a current pixel of an image processing device.

FIGS. 8A and 8B are diagrams for describing an example of a method of calculating a distance between M×M first regions adjacent to the current pixel and converting contrast of the current pixel through calculation in the method of operating an image processing device.

FIG. 9 is a block diagram illustrating an example of an application processor.

FIG. 10 is a block diagram illustrating an example of a portable terminal.

### DETAILED DESCRIPTION

Hereinafter, implementations of the present disclosure will be described in detail with reference to the accompanying drawings.

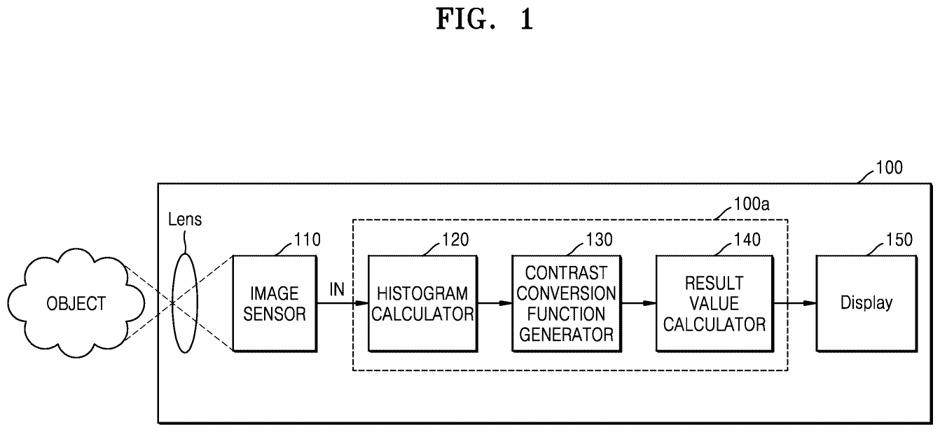

FIG. 1 is a block diagram illustrating an example of an image processing system.

An image processing system 100 may be embedded in an electronic device or implemented as the electronic device. The electronic device that is a device that captures images and displays the captured images or performs an operation based on an image may include, for example, digital cameras, smartphones, wearable devices, Internet of Things (IoT) devices, personal computers (PCs), tablet PCs, personal digital assistants (PDAs), portable multimedia players (PMPs), navigation devices, drones, and the like, or may be mounted on electronic equipment provided in vehicles, medical instruments, furniture, manufacturing facilities, security devices, doors, a variety of measurement instruments, as parts.

Referring to FIG. 1, the image processing system 100 may include an image sensor 110, a histogram calculator 120, a contrast conversion function generator 130, a result value calculator 140, and a display 150. The image processing system 100 may further include other components such as a user interface, an image signal processor, a memory, and the like.

The image sensor 110 may convert optical signals of an incident object through an optical lens into electrical signals and may generate images (or may also be referred to as image data, and hereinafter, referred to as images) based on the electrical signals. The images may include a plurality of pixels. For example, the images may be videos including a plurality of frames. The size of each of the plurality of frames may be h×w (where h and w are natural numbers greater than 0). For example, when the size of each of the plurality of frames is h×w, each of the plurality of frames may include h×w pixels. However, the number of pixels included in a frame is not limited thereto. Each of the pixels may have a pixel value.

The image sensor 110 may include a pixel array including a plurality of pixels two-dimensionally arranged, and a sensing circuit, and the pixel array may convert received optical signals into electrical signals. The pixel array may be implemented as a photoelectric conversion device such as a charge coupled device (CCD) or a complementary metal oxide semiconductor (CMOS), and may also be implemented as a variety of photoelectric conversion elements. The sensing circuit may convert electrical signals provided from the pixel array into images and may output the images as primitive images. The image sensor 110 may be implemented as a semiconductor chip including the pixel array and the sensing circuit.

Each of the histogram calculator 120, the contrast conversion function generator 130, and the result value calculator 140 may be implemented by hardware or software. When each of the histogram calculator 120, the contrast conversion function generator 130 and the result value calculator 140 is implemented by hardware, the histogram calculator 120, the contrast conversion function generator 130, and the result value calculator 140 may also be referred to as a histogram calculating circuit, a contrast conversion function generating circuit, and a result value calculating circuit, respectively, and hereinafter, are referred to as the histogram calculator 120, the contrast conversion function generator 130, and the result value calculator 140, respectively.

The histogram calculator 120 may receive images IN as an input and may split the received images IN into specific regions. In some implementations, the histogram calculator 120 may receive the images IN from the image sensor 110 as an input. For example, the received images IN may be specific frames of a video including a plurality of frames, and the size of the received images IN may be h×w (where h and w are natural numbers greater than 0). In some implementations, the histogram calculator 120 may split the received images IN into a plurality of first regions, and the plurality of first regions may be rectangular regions. For example, the histogram calculator 120 may split the received images IN into N×N (where N is a natural number greater than or equal to 2) first regions, and the size of the first regions may be h/N×w/N.

The histogram calculator 120 may calculate a histogram for the split regions. In some implementations, the histogram calculator 120 may include regions split for each of the split regions, and may calculate a histogram for a greater region than the size of the split regions. For example, the histogram calculator 120 may include a first region for each of a plurality of first regions, and may calculate a histogram for a greater second region than the first region. For example, when the size of the first region is h/N×w/N, the second region may include a first region and the size of the second region may be (h/N) (1+a)×(w/N) (1+b). For example, a and b may be real numbers greater than or equal to zero. However, figures of a and b are not limited thereto.

In some implementations, a histogram may mean that frequency distribution shown as a table is represented by an information picture, and the histogram calculator 120 may calculate the histogram based on pixel values for split regions. For example, the histogram calculator 120 may calculate the number of pixels corresponding to pixel values based on pixel values for second regions corresponding to each of a plurality of first regions and may represent the calculation result as a histogram. For example, the pixel value may be one of 0 to 255.

When the histogram calculator 120 includes regions split for each of the split regions and calculates a histogram for a greater region than the size of the split regions, the histogram calculator 120 may calculate a histogram for a wider region. Thus, brightness information about an object or background of a peripheral region may be reflected in the histogram in a region that is being currently calculated. Thus, histograms having strong changes in brightness for movement of an object or background between two continuous images (i.e., (1) a specific frame and (2) a frame before the specific frame or (3) a specific frame or (4) a frame after the specific frame) may be generated.

The contrast conversion function generator 130 may generate contrast conversion functions based on the calculated histogram. In some implementations, the contrast conversion function generator 130 may receive histograms for each of a plurality of first regions from the histogram calculator 120 and may generate contrast conversion functions for each of the plurality of first regions based on the received histograms.

In some implementations, the contrast conversion function generator 130 may generate contrast conversion functions by using a cumulative sum of histograms by using a cumulative distribution function (CDF). For example, the contrast conversion function generator 130 may generate contrast conversion functions by cumulating the number of pixels corresponding to one of 0 to 255.

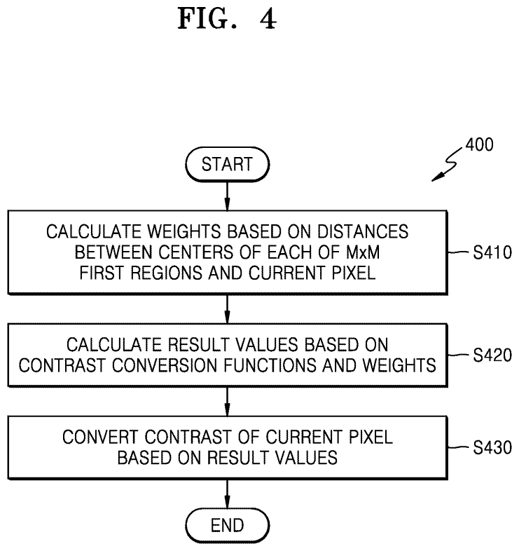

The result value calculator 140 may convert contrast of a specific pixel based on regions adjacent to a specific pixel of which contrast is to be converted. In some implementations, the result value calculator 140 may convert contrast of a current pixel based on M×M (where M is a natural number greater than or equal to 2) first regions adjacent to the current pixel among the plurality of first regions. The current pixel may be one of pixels of which contrast is to be converted, and pixels of which contrast is to be converted may be pixels included in the images IN received by the histogram calculator 120 as an input. For example, the result value calculator 140 may receive contrast conversion functions of each of M×M first regions adjacent to the current pixel from the contrast conversion function generator 130. The result value calculator 140 may calculate a distance between the current pixel and centers of each of the M×M first regions and may take the calculated distance by reverse numbers, thereby aligning the reverse numbers in a descending order. Weights for each of M×M first regions may be calculated based on the aligned order. The result value calculator 140 may convert contrast of the current pixel based on the weights of each of M×M first regions and contrast conversion functions. Detailed implementations thereof will be described below with reference to FIG. 4.

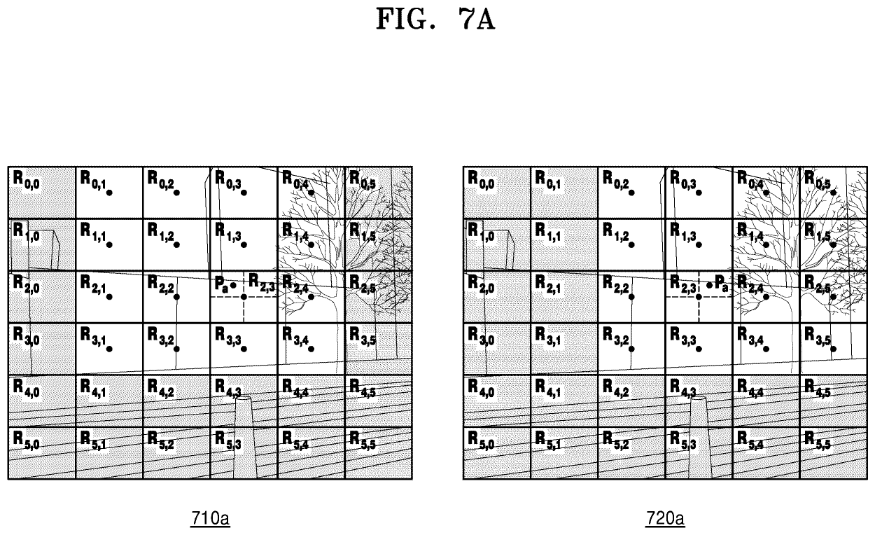

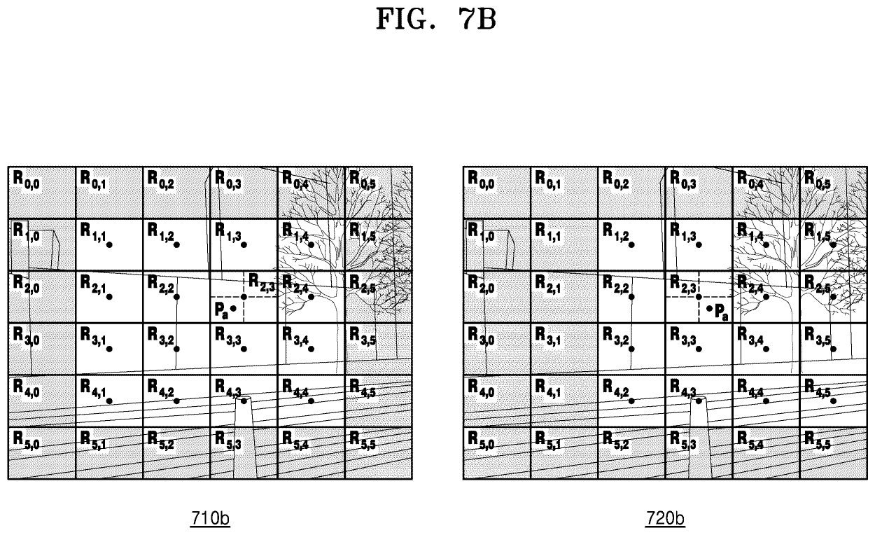

In some implementations, the result value calculator 140 may determine M×M first regions adjacent to the current pixel, and a method of determining the adjacent M×M first regions will be described below with reference to FIGS. 7A and 7B.

In some implementations, the images IN (e.g., a specific frame of a video including a plurality of frames) received by the histogram calculator 120 may include a plurality of pixels, and the current pixel may be one of the plurality of pixels. The result value calculator 140 may perform a contrast conversion operation on all of the plurality of pixels contained in the received images IN. The result value calculator 140 may perform the contrast conversion operation on all of the plurality of pixels to generate converted images. The converted images may be images of which contrast of the images IN received by the histogram calculator 120 is improved.

The result value calculator 140 may set the adjacent region wider, thereby considering contrast conversion functions of a peripheral region of the current pixel more and more when converting the contrast of the current pixel. Thus, contrast improvement results in which, even when there are large changes in histograms between two continuous images (e.g., a second frame and a first frame before the second frame or a second frame and a third frame after the second frame), brightness changes are stable without brightness changes in a local region, may be generated.

Also, when calculating weights for M×M first regions, the result value calculator 140 calculates the weights based on alignment in a descending order by taking reverse numbers of the distance so that the computation amount may be simple. Thus, the result value calculator 140 may be easily implemented.

The display 150 may be an output device that visually displays information for visual or stereoscopical reception, storing, and transfer. In some implementations, the display 150 may receive images from conversion by the result value calculator 140 and may display the received images visually.

In some implementations, the image processing system 100 may include an image sensor 110, an image processing device 100a, and a display 150. The image processing device 100a may include a histogram calculator 120, a contrast conversion function generator 130, and a result value calculator 140 and may receive the images IN from the image sensor 110 as an input. The image processing device 100a may calculate histograms for a wider region based on the images IN and may generate contrast conversion functions based on the calculated histograms, thereby reflecting brightness information of an object or background of the peripheral region in a histogram in a region that is currently being calculated. Also, the image processing device 100a may set the adjacent region wider when converting contrast for pixels included in the images IN, thereby considering contrast conversion functions of the peripheral region of the pixels more and more. Thus, contrast improvement results in which, even when there are large changes in histogram between two continuous images, brightness changes are stable without brightness changes in a local region, may be generated.

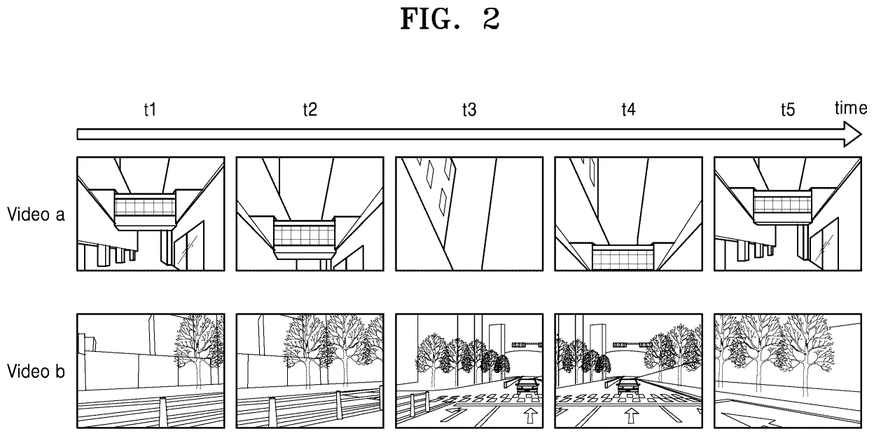

FIG. 2 is an example diagram for describing images including a plurality of frames.

Referring to FIG. 2, a first video Video a or a second video Video b may be a video in which movement of an object or background gets larger as time elapses. For example, the first video Video a may indicate that when time is moved from t1 to t5, the object or background may significantly move up and down, and the second video Video b may indicate that when time is moved from t1 from t5, the object or background may significantly move from side to side. The first video Video a or the second video Video b may include a plurality of frames, and each of the plurality of frames may include a plurality of pixels.

Referring further to FIG. 1, the image processing system 100 may receive the first video Video a or the second video Video b as an input and may perform a contrast improvement operation for a specific frame of the first video Video a or the second video Video b. The contrast improvement operation may include a histogram calculation operation performed by the histogram calculator 120 described above with reference to FIG. 1 and a contrast conversion operation performed by the result value calculator 140. The image processing system 100 may solve the problem of suddenly increasing brightness of a local region in the images captured by rotating up and down or left and right and may effectively improve contrast.

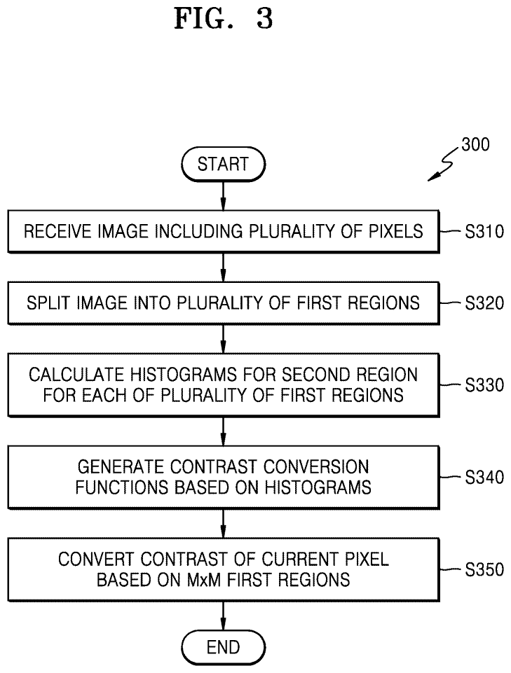

FIG. 3 is a flowchart illustrating an example of a method of operating an image processing device. As shown in FIG. 3, a method 300 of operating an image processing device may include a plurality of operations S310 to S350. Referring to FIGS. 1 and 3, the image processing device 100aof FIG. 1 may perform the method 300 of operating an image processing device, and redundant descriptions given with reference to FIG. 1 will be omitted.

In operation S310, images including a plurality of pixels may be received. In some implementations, the histogram calculator 120 may receive the images including a plurality of pixels, and the size of the received image may be h×w (where h and w are natural numbers greater than 0).

In operation S320, the images may be split into a plurality of first regions. In some implementations, the histogram calculator 120 may split the received images into N×N (where N is a natural number greater than or equal to 2) first regions, and the size of the first regions may be h/N×w/N. In some implementations, N may have different values according to the received images. For example, when pixels of the received images have similar pixel values, the images may be split into wider regions so that the number of split regions may be reduced. N may be a relatively small value. For example, when pixels of the received images have different pixel values, the images may be split into narrower regions so that the number of split regions may be increased. N may be a relatively large value.

In operation S330, histograms for a second region for each of the plurality of first regions may be calculated. In some implementations, the histogram calculator 120 may include a first region for each of a plurality of first regions, and may calculate histograms for a greater second region than the first region. For example, when the size of the first region is h/N×w/N, the second region may include a first region and the size of the second region may be (h/N) (1+a)×(w/N) (1+b). For example, a and b may be real numbers greater than or equal to zero.

In some implementations, the histogram calculator 120 may calculate the number of pixels corresponding to pixel values based on pixel values for second regions corresponding to each of a plurality of first regions and may represent the calculation result as a histogram. For example, the pixel value may be one of 0 to 255.

In operation S340, contrast conversion functions may be generated based on the histograms. In some implementations, the contrast conversion function generator 130 may receive histograms for each of a plurality of first regions from the histogram calculator 120 and may generate contrast conversion functions for each of the plurality of first regions based on the received histograms.

In some implementations, the contrast conversion function generator 130 may generate contrast conversion functions by using a cumulative sum of histograms by using a CDF. For example, the contrast conversion function generator 130 may generate contrast conversion functions by cumulating the number of pixels corresponding to one of 0 to 255.

In operation S350, contrast of the current pixel may be converted based on M×M first regions. In some implementations, the result value calculator 140 may convert contrast of a current pixel based on M×M (where M is a natural number greater than or equal to 2) first regions adjacent to the current pixel among the plurality of first regions. For example, the result value calculator 140 may receive contrast conversion functions of each of M×M first regions adjacent to the current pixel from the contrast conversion function generator 130. The result value calculator 140 may calculate a distance between the current pixel and centers of each of the M×M first regions and may take the calculated distance by reverse numbers, thereby aligning the reverse numbers in a descending order. Weights for each of M×M first regions may be calculated based on the aligned order. The result value calculator 140 may convert contrast of the current pixel based on the weights of M×M first regions and contrast conversion functions.

Since the image processing may calculate a histogram for a wider region, brightness information of an object or background of a peripheral region may be reflected in the histogram of a region that is being currently calculated. Thus, histograms having strong changes in brightness for movement of an object or background between two continuous images (i.e., 1) a specific frame and 2) a frame before the specific frame or 3) a specific frame and 4) a frame after the specific frame) may be generated.

Also, the adjacent region may be set wider so that contrast conversion functions of a peripheral region of the current pixel may be considered more and more when converting the contrast of the current pixel. Thus, contrast improvement results in which, even when there are large changes in histograms between two continuous images (e.g., a second frame and a first frame before the second frame or a second frame and a third frame after the second frame), brightness changes are stable without brightness changes in a local region, may be generated.

FIG. 4 is a flowchart illustrating an example of a method of converting contrast of a current pixel in the method of operating an image processing device. Referring to FIG. 4, a method 400 of converting contrast of a current pixel may include a plurality of operations S410 to S430. Referring to FIG. 1, the image processing device 100a of FIG. 1 may perform the method 400 of converting contrast of a current pixel, and redundant descriptions given with reference to FIG. 1 will be omitted. The method 400 may be included in operation S350 of FIG. 3, and redundant descriptions given with reference to FIG. 3 will be omitted.

In operation S410, the image processing device 100a may calculate weights based on distances between centers of each of the M×M first regions and the current pixel. In some implementations, the result value calculator 140 may calculate weights by taking the distances between the centers of each of M×M first regions and the current pixel by reverse numbers based on an order in which the distances converted into reciprocal numbers are aligned in a descending order.

In some implementations, the result value calculator 140 may calculate weights by using the following [Equation 1].

$${d}_{i , j} = \{ {f}_{r o w}^{s} ( {d}_{y \_ row ( i )} ) \times {f}_{c o l}^{s} ( {d}_{x \_ col ( j )} ) \} + λ \qquad [ Equation 1 ]$$

d_{i,j} may be weights in a first region in an i-th row and a j-th column among M×M first regions, d_{x_col(j)} and d_{y_row(i)} may be a first direction (e.g., x-axis direction) distance and a second direction (e.g., y-axis direction) distance, respectively, between the current pixel and a center of the first region in the i-th row and the j-th column of the M×M first regions, f_{row}^{s} and f_{col}^{s} may mean that d_{y_1}, . . . , d_{y_M} and d_{x_1}, . . . , d_{x_M} are aligned in a descending order based on sizes of

$$\frac{1}{{d}_{y \_ row ( i )}} and \frac{1}{{d}_{x \_ col ( j )}} ,$$

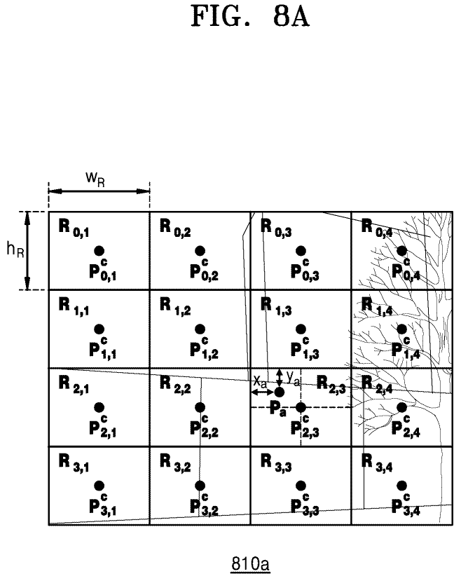

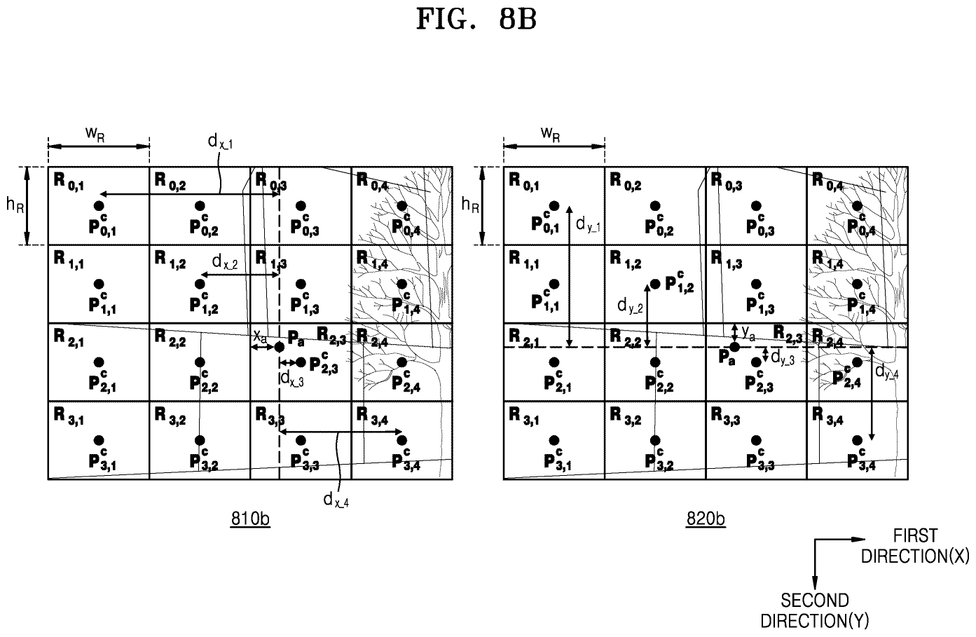

and λ may be a variable for adjusting the effect of distance weights. Specific examples of calculating weights based on the order in which the distance is taken by the reverse number and the distance taken by the reverse number is aligned in a descending order, will be described later with reference to FIGS. 8A and 8B.

In some implementations, λ may be differently set according to a user of an image processing device. For example, when λ is set large, in [Equation 1], the effect of weights according to a distance between the current pixel and the center of M×M first regions may be reduced, and when λ is set small, in [Equation 1], the effect of weights according to the distance between the current pixel and the center of the M×M first regions may be increased.

In operation S420, result values may be calculated based on contrast conversion functions and weights. In some implementations, the result value calculator 140 may generate contrast conversion result values by using the following [Equation 2].

$$O = \frac{1}{D} {\sum }_{( i , j ) ∈ {N}_{R}} {d}_{i , j} \times {T}_{i , j} \{ I \} \qquad [ Equation 2 ]$$

O may be contrast conversion result values, D may be the sum of weights in M×M first regions, i and j may be natural numbers that are greater than or equal to 1 and less than or equal to M, N_{R} may be an i-th row and j-th column index set in the M×M first regions, d_{i,j} may be weights in the first region corresponding to the i-th row and the j-th column of the index set, T_{i,j} may be contrast conversion functions in the first region corresponding to the i-th row and the j-th column of the index set, and I may be contrast of the current pixel. The contrast of the current pixel may mean values of the current pixel.

In operation S430, contrast of the current pixel may be converted based on the result values. In some implementations, the result value calculator 140 may convert values of the current pixel into contrast conversion result values to convert the contrast of the current pixel.

In some implementations, the images (e.g., a specific frame of a video including a plurality of frames) received by the histogram calculator 120 may include a plurality of pixels, and the current pixel may be one of the plurality of pixels. The result value calculator 140 may calculate contrast conversion result values for all of the plurality of pixels included in the received images and may convert pixel values of each of the plurality of pixels into contrast conversion result values to generate converted images. The converted images may be images of which contrast of the images received by the histogram calculator 120 is improved.

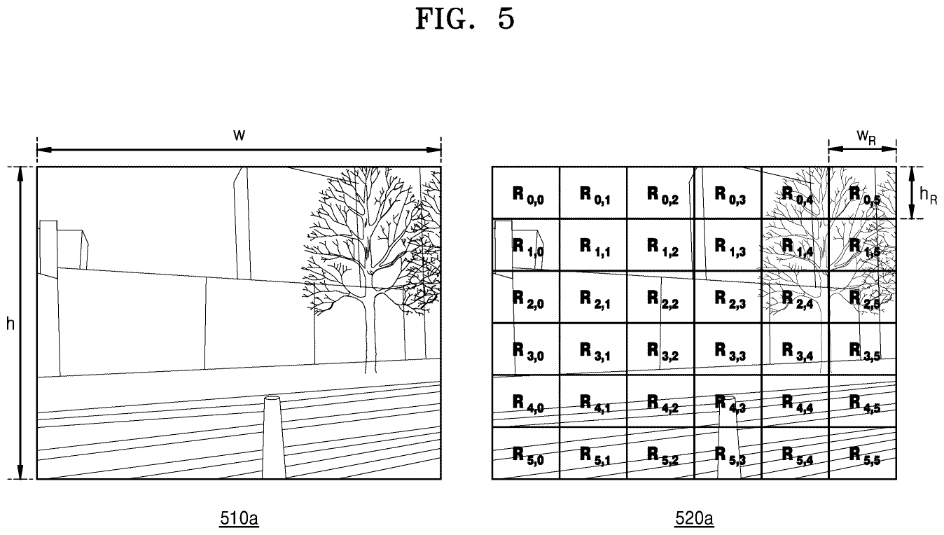

FIG. 5 is a diagram for describing an example of a method of splitting an image into a plurality of regions in the method of operating an image processing device. Referring to FIGS. 1 and 5, the image processing device 100a of FIG. 1 may perform a method of splitting an image into a plurality of regions, and redundant descriptions given with reference to FIG. 1 will be omitted.

An image 510a may be a specific frame of a video including a plurality of frames. The size of the image 510a may be h×w (where h and w are natural numbers greater than 0) and may include h×w pixels. Each of the h×w pixels may include pixel values.

The histogram calculator 120 may receive the image 510a as an input and may split the image 510a into specific regions. In some implementations, the image 520b may be images obtained by splitting the image 510a into specific regions by using the histogram calculator 120. For example, the histogram calculator 120 may split the image 510a into 6×6 specific regions. A region R_{i,j} may mean a region in an i-th row and a j-th column of specific regions, and the size of the specific regions may be w_{R}×h_{R}. Since the image 510a is split into 6×6 specific regions, w_{R} may be w/6 and h_{R} may be h/6.

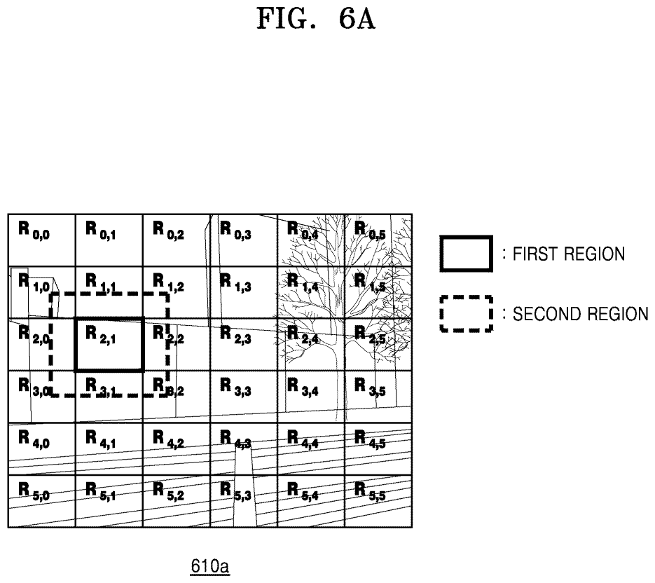

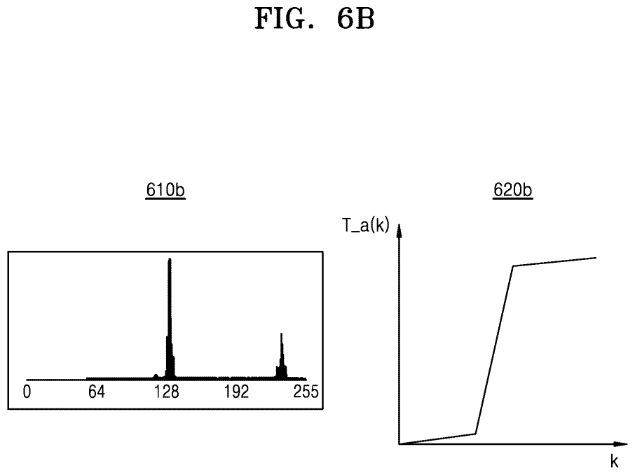

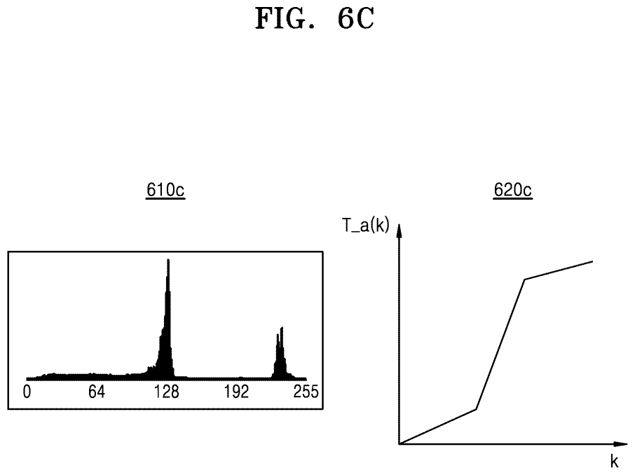

FIGS. 6A through 6C are diagrams for describing an example of a method of calculating a histogram and a method of generating a contrast conversion function in the method of operating an image processing device. Referring to FIGS. 1, 6A through 6C, the image processing device 100a of FIG. 1 may perform a method of calculating histograms and a method of generating contrast conversion functions, and redundant descriptions given with reference to FIG. 1 will be omitted.

An image 610a may be identical to the image 520b of FIG. 5. The histogram calculator 120 may calculate histograms for the split regions. In some implementations, the histogram calculator 120 may calculate histograms for the same regions as the split regions. For example, the histogram calculator 120 may calculate histograms for a first region when calculating a histogram for a region R_{2,1}. The size of the first region may be w_{R}×h_{R} that is identical to the size of the region R_{2,1}.

A histogram 610b of FIG. 6B may be a histogram expressed by calculating the number of pixels corresponding to pixel values for the first region when the histogram calculator 120 calculates the histogram for the region R_{2,1}, and the horizontal axis may represent pixel values (e.g., one of 0 to 255) of pixels included in the region R_{2,1}. The vertical axis may represent the number of pixels corresponding to the pixel values as a bar graph. For example, when the number of pixels corresponding to a first pixel value is less than the number of pixels corresponding to a second pixel value, the size of a bar graph corresponding to the first pixel value may be less than the size of a bar graph corresponding to the second pixel value. A graph 620b of FIG. 6B may be a graph representing the result in which the contrast conversion function generator 130 generates contrast conversion functions by using a CDF based on the histogram 610b. The horizontal axis of the graph 620b may represent a pixel value k, and the vertical axis of the graph 620b may represent result values when the pixel value k is applied to the contrast conversion functions.

In some implementations, the histogram calculator 120 may include regions split for each of the split regions and may calculate histograms for a greater region than the size of the split regions. For example, the histogram calculator 120 may calculate histograms for a second region when calculating a histogram for a region R_{2,1}. The size of the second region may be (1+a)w_{R}×(1+b)h_{R}. For example, a and b may be real numbers greater than or equal to zero.

A histogram 610c of FIG. 6C may be a histogram expressed by calculating the number of pixels corresponding to pixel values for the second region when the histogram calculator 120 calculates the histogram for the region R_{2,1}, and the horizontal axis may represent pixel values (e.g., one of 0 to 255) of pixels included in the region R_{2,1}. The vertical axis may represent the number of pixels corresponding to the pixel values as a bar graph. For example, when the number of pixels corresponding to a first pixel value is less than the number of pixels corresponding to a second pixel value, the size of a bar graph corresponding to the first pixel value may be less than the size of a bar graph corresponding to the second pixel value. A graph 620c of FIG. 6C may be a graph representing the result in which the contrast conversion function generator 130 generates contrast conversion functions by using a CDF based on the histogram 610c. The horizontal axis of the graph 620c may represent a pixel value k, and the vertical axis of the graph 620c may represent result values when the pixel value k is applied to the contrast conversion functions.

Comparing the histogram 610b to the histogram 610c, the pixel value distribution of the histogram 610c is more diverse than the pixel value distribution of the histogram 610b, so that when calculating the histogram corresponding to the same region, it may be checked that calculating of the histogram in a wider region has more diverse pixel value distribution. Also, comparing the graph 620b to the graph 620c, it may be checked that the gradient of the graph 620c is gentle compared to the graph 620b. Thus, histograms having strong changes in brightness for movement of an object or background between two continuous images (i.e., a specific frame and a frame before the specific frame or a specific frame or a frame after the specific frame) may be generated.

FIGS. 7A and 7B are diagrams for describing an example of a method of determining M×M first regions adjacent to a current pixel of an image processing device. Referring to FIGS. 1, 7A and 7B, the image processing device 100a of FIG. 1 may perform a method of determining M×M first regions adjacent to the current pixel, and redundant descriptions given with reference to FIG. 1 will be omitted.

The result value calculator 140 may determine M×M first regions adjacent to the current pixel Pa among the plurality of first regions and may convert contrast of the current pixel Pa based on the M×M first regions. In some implementations, the result value calculator 140 may determine adjacent M×M first regions based on the relationship between the center of the first region including a current pixel Pa and the current pixel Pa.

For example, when the region R_{2,3} including the current pixel PA is split into four parts at the center of the region R_{2,3}, the region R_{2,3} may be split into a first quadrant, a second quadrant, a third quadrant, and a fourth quadrant. When M is 4, the result value calculator 140 may determine the 4×4 first regions adjacent to the current pixel Pa based on the quadrant of the current pixel Pa. An image 710a may represent the case where the current pixel is located at the first quadrant. When the current pixel Pa is located at the first quadrant, the result value calculator 140 may represent 4×4 first regions adjacent to the first quadrant. For example, R_{0,1}, R_{0,2}, . . . , and R_{3,4} may be first regions adjacent to the current pixel Pa. An image 720a may represent the case where the current pixel is located at the second quadrant. When the current pixel Pa is located at the second quadrant, the result value calculator 140 may represent 4×4 first regions adjacent to the second quadrant. For example, R_{0,2}, R_{0,3}, . . . , and R_{3,5} may be first regions adjacent to the current pixel Pa. An image 710b may represent the case where the current pixel is located at the third quadrant. When the current pixel Pa is located at the third quadrant, the result value calculator 140 may represent 4×4 first regions adjacent to the third quadrant. For example, R_{1,1}, R_{1,2}, . . . , and R_{4,4} may be first regions adjacent to the current pixel Pa. An image 710b may represent the case where the current pixel is located at the fourth quadrant. When the current pixel Pa is located at the fourth quadrant, the result value calculator 140 may represent 4×4 first regions adjacent to the fourth quadrant. For example, R_{1,2}, R_{1,3}, . . . , and R_{4,5} may be first regions adjacent to the current pixel Pa.

FIGS. 8A and 8B are diagrams for describing an example of a method of calculating a distance between M×M first regions adjacent to the current pixel converting contrast of the current pixel through calculation in the method of operating an image processing device. Referring to FIGS. 1, 8A and 8B, the image processing device 100a of FIG. 1 may perform a method of converting contrast of the current pixel, and redundant descriptions given with reference to FIG. 1 will be omitted.

The result value calculator 140 may determine M×M first regions adjacent to the current pixel Pa among the plurality of first regions. In some implementations, the result value calculator 140 may determine adjacent M×M first regions based on the relationship between the center of the first region including a current pixel Pa and the current pixel Pa. For example, since M is 4 and the current pixel Pa is located at the first quadrant of the region R_{2,3} including the current pixel Pa, the adjacent 4×4 first regions may be determined as an image 810a. The image 810a may be part of the image 710a of FIG. 7A. The adjacent 4×4 first regions determined at the image 810a may be adjacent 4×4 first regions determined at the image 710a of FIG. 7A. R_{i,j} may mean a first region located in an i-th row and a j-th column of 4×4 first regions, P^{C}_{i,j} may mean the center (or means center coordinates, and hereinafter, referred to as a center) of the first region located in the i-th row and the j-th column among 4×4 first regions. The position of the current pixel Pa may be a position where the current pixel Pa is moved by xa in a first direction (x-axis direction) and by ya in a second direction (y-axis direction) based on the top left of the region R_{2,3} including the current pixel Pa.

In some implementations, the result value calculator 140 may calculate weights based on the distance between centers of each of the M×M first regions and the current pixel Pa. The image 810b may be a diagram for explaining a process of obtaining a first direction (e.g., x-axis direction) distance between the center P^{C}_{i,j} of the adjacent 4×4 first regions and the current pixel Pa, and the image 820b is a diagram for explaining a process of obtaining a second direction (e.g., y-axis direction) distance between the center P^{C}_{i,j} of the adjacent 4×4 first regions and the current pixel Pa. For example, since the size of the first region R_{i,j} is w_{R}×h_{R} and coordinates of the current pixel Pa is (xₐ, yₐ), the x-axis direction distance dx_1 to dx_4 and the y-axis direction distance dy_1 to dy_4 may be represented by the following [Table 1].

[Equation 1]

| | |
|---|---|
| X-axis direction | dₓ_1 = 1.5 · W_{R} + xₐ, |
| distance | dₓ_2 = 0.5 · W_{R} + xₐ |
| | dₓ_3 = 0.5 · W_{R} − xₐ |
| | dₓ_4 = 1.5 · W_{R} − xₐ |
| Y-axis direction | d_{y}_1 = 1.5 · W_{R} + yₐ |
| distance | d_{y}_2 = 0.5 · W_{R} + yₐ |
| | d_{y}_3 = 0.5 · W_{R} − yₐ |
| | d_{y}_4 = 1.5 · W_{R} − yₐ |

When [Equation 1] of FIG. 4 is applied to the x-axis direction distance (dx_1 to dx_4) and the y-axis direction distance (dy_1 to dy_4), f_{row}^{s} and f_{col}^{s} may represent that d_{y_1}, . . . , d_{y_4} and d_{x_1}, . . . , d_{x_4} are aligned in a descending order based on the size of

$$\frac{1}{{d}_{y \_ row ( i )}} and \frac{1}{{d}_{x \_ col ( j )}} ,$$

and f_{row}^{s} and f_{col}^{s} may be expressed by the following [Table 2].

| | |
|---|---|
| f_{row}^{s} | f_{row}^{s} (d_{y}_3) = 1.5 · W_{R} + yₐ |
| | f_{row}^{s} (d_{y}_2) = 1.5 · W_{R} − yₐ |
| | f_{row}^{s} (d_{y}_4) = 0.5 · W_{R} + yₐ |
| | f_{row}^{s} (d_{y}_1) = 0.5 · W_{R} − yₐ |
| f_{col}^{s} | f_{col}^{s} (dₓ_3) = 1.5 · W_{R} + xₐ |
| | f_{col}^{s} (dₓ_2) = 1.5 · W_{R} − xₐ |
| | f_{col}^{s} (dₓ_4) = 0.5 · W_{R} + xₐ |
| | f_{col}^{s} (dₓ_1) = 0.5 · W_{R} − xₐ |

When the value of [Table 2] is assigned to [Equation 1] of FIG. 4, weights may be calculated. Since the result value calculator 140 calculates weights by aligning the weights in a descending order based on the size of reverse numbers of the distance, the weights may be calculated smaller for distant regions from the current pixel Pa and the distant region and the weights may be largely calculated for nearby regions. Thus, while the computation amount required for weight calculation is simple, contrast conversion functions of a peripheral region of the current pixel Pa may be considered more and more when the contrast of the current pixel Pa is converted.

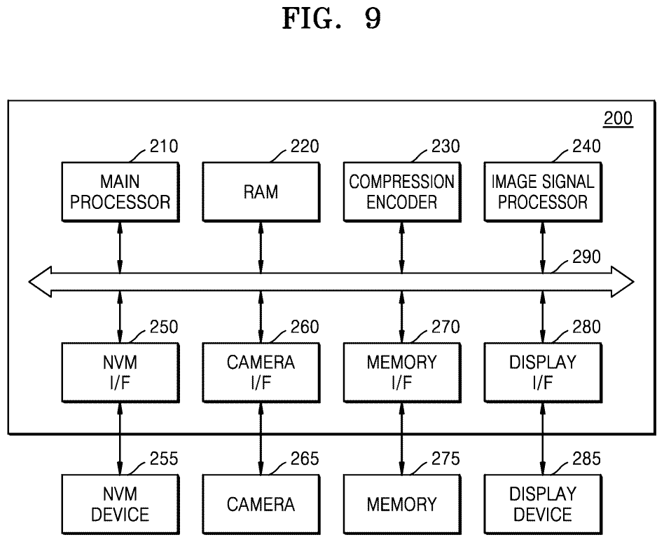

FIG. 9 is a block diagram illustrating an example of an application processor.

Referring to FIG. 9, an application processor 200 may include a main processor 210, random access memory (RAM) 220, a compression encoder 230, an image signal processor 240, a nonvolatile memory interface 250, a camera interface 260, a memory interface 270, and a display interface 280. Each of the components (i.e., 210, 220, 230, 240, 250, 260, 270, and 280) of the application processor 200 may transmit/receive data to/from each other via a bus 290.

The main processor 210 may control the overall operation of the application processor 200. The main processor 210 may be implemented as a central processing unit (CPU), a microprocessor, or the like and in some implementations, may be implemented as one computing component having two or more independent processors (or cores), i.e., multi-core processors. The main processor 210 may process or execute programs and/or data stored in the RAM 220 (or ROM).

In some implementations, the main processor 210 may perform the same operations of the histogram calculator 120, the contrast conversion function generator 130, and the result value calculator 140 described above with reference to FIGS. 1 through 8B. For example, the main processor 210 may receive a specific frame including a plurality of pixels from the outside as an input and may split the specific frame into first regions. The main processor 210 may calculate histograms including a first region for each of first regions and for a second region that is greater than a first region and may generate contrast conversion functions based on the calculated histograms. The main processor 210 may calculate a result value of the current pixel of the specific frame based on adjacent M×M first regions of the current pixel and may generate the converted specific frame based on the result value. The converted specific frame may be an image having improved contrast. Accordingly, the main processor 210 may effectively improve the contrast of the image at a backlight or low light place where a lighting environment is poor, and even when the intensity of the effect of contrast improvement is increased, flickering problems in which brightness suddenly becomes bright or dark in images may be solved.

The RAM 220 may temporarily store programs, data, and/or instructions. In some implementations, the RAM 220 may be implemented as dynamic RAM (DRAM) or static RAM (SRAM). The RAM 220 may temporarily store an image that is input/output through interfaces (i.e., 250, 260, 270, and 280) or generated by the image signal processor 240 or the main processor 210.

In some implementations, the application processor 200 may further include read only memory (ROM). The ROM may store programs and/or data used continuously. The ROM may be implemented as erasable programmable ROM (EPROM), electrically erasable programmable ROM (EEPROM) or the like.

A nonvolatile memory interface 250 may interface with data input from the nonvolatile memory device 255 or data output to the nonvolatile memory. The nonvolatile memory device 255 may be implemented as, for example, a MultiMediaCard (MMC), an embedded MMC (eMMC), a secure digital (SD) card, a micro SD card, or the like.

A camera interface 260 may interface with data (e.g., a primitive image) input from a camera 265 located outside the application processor 200. The camera 265 may generate data about an image captured by using a plurality of photosensitive devices. The primitive image received through the camera interface 260 may be provided to an image signal processor 240 or may be stored in a memory 275 through a memory interface 270.

The memory interface 270 may interface with data input from the memory 275 outside the application processor 200 or data output to the memory 275. In some implementations, the memory 275 may be implemented as volatile memory such as DRAM or SRAM or nonvolatile memory such as ReRAM, PRAM or NAND flash, or the like.

A display interface 280 may interface with data (e.g., an image) output to the display device 285. The display device 285 may output data about an image or a video on a display such as a liquid-crystal display (LCD), an active matrix organic light-emitting diode (AMOLD) display, or the like.

The compression encoder 230 may encode the image to output an encoded image, i.e., a compressed image. The compression encoder 230 may encode a converted image output from the image signal processor 240 or a converted image stored in the memory 275. In some implementations, the compression encoder 230 may be a joint photographic experts group (JPEG) module, and the JPEG module may output a JPEG format image. The JPEG format image may be stored in the nonvolatile memory device 255.

The image signal processor 240 may perform image processing on an image provided from the camera 254, for example, a primitive image, thereby generating the converted image, storing the converted image in the memory 275, or scaling the converted image to provide the scaled image to the display device 285.

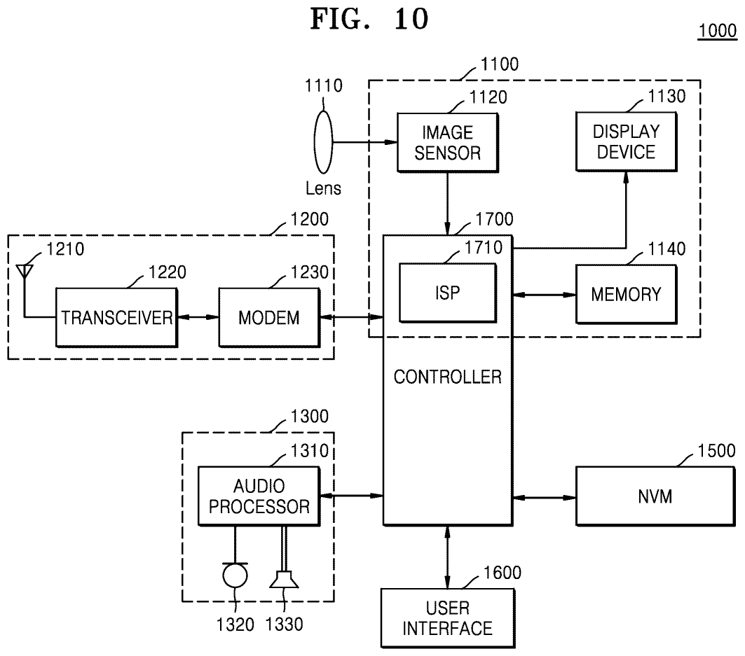

FIG. 10 is a block diagram illustrating an example of a portable terminal.

Referring to FIG. 10, a portable terminal 1000 may include an image processing unit 1100, a wireless transmitting/receiving unit 1200, an audio processing unit 1300, a nonvolatile memory device 1500, a user interface 1600, and a controller 1700.

The image processing unit 1100 may include a lens 1110, an image sensor 1120, a display device 1130, a memory 1140, and an image signal processor 1710. In some implementations, as shown in the diagram, the image signal processor 1710 may be implemented as part of the controller 1700.

In some implementations, the controller 1700 may perform the same operations of the histogram calculator 120, the contrast conversion function generator 130, and the result value calculator 140 described above with reference to FIGS. 1 through 8B. For example, the controller 1700 may receive a specific frame including a plurality of pixels from the image sensor 1120 as an input and may split the specific frame into first regions. The controller 1700 may calculate histograms including a first region for each of first regions and for a second region that is greater than a first region and may generate contrast conversion functions based on the calculated histograms. The controller 1700 may calculate a result value of the current pixel of the specific frame based on adjacent M×M first regions of the current pixel and may generate the converted specific frame based on the result value. The converted specific frame may be an image having improved contrast. Thus, the controller 1700 may effectively improve the contrast of the image at the backlight or low light place where the lighting environment is poor, and even when the intensity of the effect of contrast improvement is increased, flickering problems in which brightness suddenly becomes bright or dark in images may be solved. In some implementations, the image signal processor 1710 may perform the same operations of the histogram calculator 120, the contrast conversion function generator 130, and the result value calculator 140 described above with reference to FIGS. 1 through 8B for the images provided from the image sensor 1120.

The wireless transmitting/receiving unit 1200 may include an antenna 1210, a transceiver 1220, and a modem 1230. The audio processing unit 1300 may include an audio processor 1310, a microphone 1320, and a speaker 1330. The nonvolatile memory device 1500 may be implemented as, for example, an MMC, an eMMC, an SD card, a micro SD card, or the like.

The user interface 1600 may be implemented as various devices that may receive user input, such as a keyboard, a curtain key panel, a touch panel, a fingerprint sensor, a microphone, or the like. The user interface 1600 may receive user input and may provide signals corresponding to the received user input to the controller 1700.

The controller 1700 may control the overall operation of the portable terminal 1000 and may be provided as a system on chip (SoC) for driving an application program, an operating system, or the like. The kernel of the operating system driven by the SoC may include an input/output scheduler and a device driver for controlling the nonvolatile memory device 1500.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

As described above, implementations have been disclosed in drawings and specifications. Although the implementations have been described using a specific term herein, this is used in the purpose of explaining the technical thoughts of the present disclosure, not to be used to limit the scope of the present disclosure described in the meaning of meaning or claim. Thus, it will be understood by one of ordinary skill in the art that a variety of modifications and equal examples are possible therefrom. Therefore, the true technical protection scope of this disclosure should be determined by the technical ideas of the attached claims.

While the present disclosure has been particularly shown and described with reference to implementations thereof. it will be understood that various changes in form and details may be made therein without departing from the spirit and scope of the following claims.

What is claimed is:

1. A method of operating an image processing device, the method comprising:
receiving an image including a plurality of pixels;
splitting the image into a plurality of first regions;
calculating a plurality of histograms for a plurality of second regions corresponding to the plurality of the first regions, respectively, wherein each second region includes the corresponding first region and is greater than the corresponding first region;
generating a plurality of contrast conversion functions based on the plurality of histograms for the plurality of first regions; and
converting contrast of a current pixel of the plurality of pixels based on M×M first regions among the plurality of first regions, wherein M is a natural number greater than or equal to 2, and the M×M first regions are adjacent to the current pixel.

2. The method of claim 1, wherein a size of a first region is h_{R}×w_{R} and a size of a second region is (1+a)h_{R}×(1+b)w_{R}, h_{R} and w_{R} are natural numbers greater than 0, and a and b are real numbers greater than or equal to 0.

3. The method of claim 1, wherein converting the contrast of the current pixel comprises
converting the contrast of the current pixel based on M×M contrast conversion functions of the plurality of contrast conversion functions and M×M distances, wherein the M×M contrast conversion functions correspond to the M×M first regions, and each distance of the M×M distances is a distance between a center of the corresponding M×M first region and the current pixel.

4. The method of claim 3, wherein converting the contrast of the current pixel comprises:
calculating M×M weights based on the M×M distances;
calculating a result value based on the M×M contrast conversion functions and the M×M weights; and
converting the contrast of the current pixel based on the result value.

5. The method of claim 4, wherein calculating the M×M weights comprises:
taking M×M reciprocal numbers of the M×M distances;
aligning the M×M reciprocal numbers in a descending order; and
calculating the M×M weights based on the M×M reciprocal numbers in the descending order.

6. The method of claim 5, wherein calculating the M×M weights based on the M×M reciprocal numbers in the descending order comprises
calculating the M×M weights so that M×M values of the M×M weights are decreased according to the descending order.

7. The method of claim 1, wherein converting the contrast of the current pixel comprises
calculating contrast conversion result value according to the following equation:
$$O = \frac{1}{D} {\sum }_{( i , j ) ∈ {N}_{R}} {d}_{i , j} \times {T}_{i , j} \{ I \}$$
wherein O represents the contrast conversion result value, D represents a sum of weights of the M×M first regions, i and j are natural numbers that are greater than or equal to 1 and less than or equal to M, N_{R} means an i-th row and a j-th column index set of the M×M first regions, d_{i,j} represents weight of a first region corresponding to the i-th row and the j-th column of the index set, T_{i,j} represents contrast conversion functions of the first region corresponding to the i-th row and the j-th column of the index set, and I represents contrast of the current pixel.

8. The method of claim 7, wherein d_{i,j} is calculated by taking M×M reciprocal numbers of the M×M distances based on an order in which the M×M reciprocal numbers are aligned in a descending order.

9. The method of claim 8, wherein d_{i,j} is calculated by adding a variable to values calculated based on the M×M reciprocal numbers in the descending order, and wherein the variable controls an effect of distance weights.

10. The method of claim 1, wherein the M×M first regions are determined based on a position of the current pixel in a first region, in which the current pixel is included, among the plurality of first regions.

11. The method of claim 1, wherein generating the plurality of contrast conversion functions comprises generating the plurality of contrast conversion functions based on a cumulative distribution function (CDF).

12. An image processing device comprising:
a histogram calculator configured to
receive an image including a plurality of pixels,
split the image into N×N first regions, wherein N is a natural number that is greater than or equal to 2, and
calculate N×N histograms for N×N second regions corresponding to the N×N first regions, respectively, wherein each second region is greater than the corresponding first region;
a contrast conversion function generator configured to
receive the N×N histograms, and
generate N×N contrast conversion functions for the N×N first regions based on the N×N histograms; and
a result value calculator configured to perform contrast conversion of a current pixel of the plurality of pixels, wherein performing the contrast conversion comprises calculating a result value based on the N×N contrast conversion functions and H×H weights of H×H first regions among the N×N first regions, wherein H is natural number that is greater than or equal to 2 and less than or equal to N, and the H×H first regions are adjacent to the current pixel,
wherein the H×H weights are calculated by taking H×H reciprocal numbers of H×H distances based on an order in which the H×H reciprocal numbers are aligned in a descending order, and each distance of the H×H distances is a distance between a center of the corresponding H×H first region and the current pixel.

13. The image processing device of claim 12, wherein each second region includes the corresponding first region.

14. The image processing device of claim 13, wherein
a size of the image is h×w, wherein h and w are natural numbers greater than 0,
a size of a first region is h/N×w/H, and
a size of a second region is (1+a)(h/N)×(1+b)(w/N), wherein a and b are real numbers that are greater than or equal to 0.

15. The image processing device of claim 12, wherein the result value calculator is configured to calculate the H×H weights so that H×H values of the H×H weights are decreased according to the order aligned in the descending order.

16. The image processing device of claim 12, wherein the result value calculator is configured to perform contrast conversion of the current pixel by adding a variable that controls an effect of distance weights to the result value.

17. An image processing system comprising:
an image sensor configured to output image data including a plurality of pixels;
a histogram configured to
split the image data into N×N first regions, wherein N is natural number, and
calculate a plurality of histograms for a second region that is greater than a first region of the N×N first regions;
a contrast conversion function generation circuit configured to
receive the plurality of histograms, and
generate a contrast conversion function for each first region of the N×N first regions based on the plurality of histograms; and
a result value calculation circuit configured to perform contrast conversion of a current pixel of the plurality of pixels, wherein performing the contrast conversion comprises calculating a result value based on the N×N contrast conversion functions and H×H weights of H×H first regions among the N×N first regions, wherein H is natural number that is greater than or equal to 2 and less than or equal to N, and the H×H first regions are adjacent to the current pixel.

18. The image processing system of claim 17, wherein
the H×H weights are calculated by taking H×H reciprocal numbers of H×H distances based on an order in which the H×H reciprocal numbers are aligned in a descending order, and each distance of the H×H distances is a distance between a center of the corresponding H×H first region and the current pixel.

19. The image processing system of claim 18, wherein the result value calculation circuit is configured to calculate the H×H weights so that H×H values of the H×H weights are decreased according to the order aligned in the descending order.

20. The image processing system of claim 18, wherein
the result value calculation circuit is configured to perform contrast conversion of the current pixel by adding a variable that controls an effect of distance weights to the result value.
